(19) United States
(12) Patent Application Publication
(10) Pub. No.: US 2014/0270095 A1
(43) Pub. Date: Sep. 18, 2014

(54) METHOD FOR IDENTIFYING FAULT LOCATION IN NETWORK TRUNK

(71) Applicant: GENERAL INSTRUMENT CORPORATION, Horsham, PA (US)

(72) Inventors: David B Bowler, Stow, MA (US); Brian M Basile, Lancaster, MA (US)

(73) Assignee: GENERAL INSTRUMENT CORPORATION, Horsham, PA (US)

(21) Appl. No.: 13/844,727

(22) Filed: Mar. 15, 2013

(51) Int. Cl. H04M 3/30

(52) U.S. Cl. CPC H04M 3/30
USPC 379/22.03

(57) ABSTRACT

A method of estimating a location of a fault in a network including the detection of a status of nodes connected to a head end of the network via a trunk of the network as being in-service or out-of-service. A node is considered out-of-service when the head end loses communication with all terminal network devices associated with the node. In addition, a status of head end network components is monitored for faults occurring therein. The location of a fault is automatically estimated as being on the trunk of the network when the head end network components are without a monitored fault condition and when at least one node on the trunk is detected as being out-of-service.

### BACKGROUND

Program providers such as multiple system operators, television networks and stations, cable TV operators, satellite TV operators, studios, wireless service providers, and Internet broadcasters/service providers, among others, require broadband communication systems to deliver programming and like content to consumers/subscribers over networks via digital or analog signals. Such networks and physical plants tend to be extensive and complex and therefore are difficult to manage and monitor for faults, impairments, maintenance issues and the like.

Monitoring network maintenance activities particularly presents problems to operators of extensive cable networks. For purposes of example, a cable network may include a headend which is connected to several nodes that may provide access to IP or ISPN networks. The cable network may also include a variety of cables such as coaxial cables, optical fiber cables, or a Hybrid Fiber/Coaxial (HFC) cable system which interconnect terminal network elements of subscribers to the headend in a tree and branch structure. The terminal network elements (media terminal adaptors (MTAs), cable modem, set top box, etc.) reside on nodes which may be combined and serviced by common components at the headend.

Cable modems may support data connection to the Internet and other computer networks via the cable network. Thus, cable networks provide bi-directional communication systems in which data can be sent downstream from the headend to a subscriber and upstream from a subscriber to the headend. The headend typically interfaces with cable modems via a cable modem termination system (CMTS) which has several receivers. Each receiver of the CMTS may connect to numerous nodes which, in turn, may connect to numerous network elements, such as modems, media terminal adaptors (MTAs), set top boxes, terminal devices, customer premises equipment (CPE) or like devices of subscribers. A single receiver of the CMTS, for instance, may connect to several hundred or more network elements.

The conventional process for tracking which terminal devices are attached to which optical node and like information is a manual process. For instance, when a new customer's services are first enabled, a network operator may identify the specific node or location of the user and enter this information manually into a customer management database. This information can be valuable for resolving physical layer communications issues, performing periodic plant maintenance, and planning future service expansions. However, when the data is inaccurate or incomplete, it can lead to misdiagnosis of issues, excessive costs associated with maintenance, and prolonged new deployments. In addition, as communication traffic increases or new services are deployed, the need to understand loading of parts of the network becomes important, particularly if existing subscribers must be reallocated to different nodes or parts of the network.

Based on conventional practice, locating and identifying network and physical plant issues essentially relies upon the receipt of customer calls and manual technician analysis in response thereto.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a snapshot screen view of a so-called dashboard of a graphical user interface according to an embodiment.

FIG. 2 is a view of a panel of the dashboard showing a cluster of objects displayed on top of a satellite image of a geographic area into which a network extends according to an embodiment.

FIG. 3 is a view of an interactive user interface display which may provide a starting point of the dashboard once a user logs into the system according to an embodiment.

FIG. 4 is a view similar to FIG. 3 with the map further zoomed-in to a particular region of the network service area according to an embodiment.

FIG. 5 is a view of an interactive user interface display which shows an alarm tree for use in investigating information of alarms shown on the display according to an embodiment.

FIG. 6 is a view similar to FIG. 5 with the alarm tree further expanded in accordance with an embodiment.

FIG. 7 is a view of a graphical user interface with a local geographic map showing a node location, terminal network elements, network path, and alarms in accordance with an embodiment.

FIG. 8 is a view of a graphical user interface similar to FIG. 7 with a cluster of terminal network elements highlighted based on geo-proximity in accordance with an embodiment.

FIG. 9 is a view of a graphical user interface similar to FIG. 8 that is displayed on a satellite image of the geographic area according to an embodiment.

FIG. 10 is a view of a graphical user interface similar to FIG. 9 and including a listing of alarms for the cable modems displayed on the map according to an embodiment.

FIG. 11 is a view of a graphical user interface similar to FIG. 10 and including a listing of a particular performance parameter (in this instance, downstream microreflections in dBs for absolute and delta values) for the cable modems displayed on the map and channels used thereby according to an embodiment.

FIG. 12 is a view of a wireless communication tablet having a display screen that may be used by a field technician in accordance with an embodiment.

FIG. 13 is a snapshot view of a display screen of the tablet providing a list of faulted modems in accordance with an embodiment.

FIG. 14 is a snapshot view of a display screen of the tablet providing the geographic locations of the faulted modems on a street map in accordance with an embodiment.

FIG. 15 is a view of a topology of a trunk of a network extending downstream from a head end to fiber-optic nodes with a section of the trunk being estimated as a source of a fault in accordance with an embodiment.

FIG. 16 is a view of the same topology as FIG. 15 in which a head end network component is estimated as being a source of a fault in accordance with an embodiment.

FIG. 17 is a view of a display providing a detailed hub view showing the source of the fault and the nodes associated therewith in accordance with an embodiment.

FIG. 18 is a flowchart of a method of estimating a location of a fault in the trunk or hub of a network in accordance with an embodiment.

### DETAILED DESCRIPTION

For simplicity and illustrative purposes, the principles of embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

Embodiments disclosed herein are directed to automated management and monitoring systems, tools, and methods that enable issues occurring in a network, such as a cable network, to be proactively and automatically detected and located. The embodiments leverage a combination of key data and network topology such as information concerning the geographical location of an issue, the nature of the issue, and/or the severity of an issue to permit a network operator to quickly detect, isolate, locate and address problems. In addition, collection and analysis of historical, long term and periodic health information of a network provided by the embodiments can aid in determining trends that may indicate slow and steady degradation of a network element or component. Such degradation has conventionally remained undetected when relying only on manual spot checks by field technicians and only becomes detectable upon component failure.

According to embodiments, the above referenced tasks are accomplished automatically by a management and monitoring tool that is able to scale across extremely large networks thereby enabling network operators to become more proactive with network maintenance activities and to achieve higher levels of network availability and reliability. Operational costs can be reduced by decreasing the need for troubleshooting at a time after the occurrence of the problem or issue. In addition, the periodic collection and analysis of network conditions provides a view into critical network indicators and aids in resolving issues prior to customer impact.

Network monitoring can be performed such that information concerning geographic location of monitored network elements, such as cable modems or the like, and associated network component topology, such as HFC components and the like, are automatically populated into a network management database or the like for purposes of providing a visual display, such as a geographically accurate street map or satellite image of a region of a service area, that clearly indicates a fault or other issue and the geographical location thereof including issues on a trunk section of a network. For example, see the illustrative examples provided by FIGS. 15-17. Thus, the path that the network takes geographically is displayed on the map along with the physical location of network elements and components within the network. Such a map provides a useful network management tool to network operators and field technicians for resolving issues in an efficient and prompt manner.

As one contemplated example, the map can be provided as part of a graphical interface which displays faults of varying severity levels ranging from critical to completely non-service affecting. Accordingly, in at least some embodiments, the severity of a fault on the network can be determined and displayed with the estimated geographic location of the fault on the map.

In addition, the network monitoring and management system or tool can be provided and fully integrated into software that is loaded and resides on a server or remote server connected to or communicating with the network. Of course, the software may reside on other devices and equipment such as equipment located at the headend of the network, cloud devices, and portable or mobile devices. Utilization of the software eliminates the need for manual analysis of data and permits large amounts of data to be automatically analyzed electronically by microprocessors or the like on a large scale.

The network management tool or software may estimate and make assumptions regarding probable tap and passive locations, and couple this information with known optical node location data, and with walking directions data from a geographical data (geodata) services provider. Walking directions data may be in accordance with an appropriate format, language, or standard; examples include, but are not limited to, data in Keyhole Markup Language (KML), e.g., Open Geospatial Consortium (OGC) KML, or the OpenGIS KML Encoding Standard. From this cumulative information, the network management tool or software can estimate and automatically populate a map or the like of a given service area with monitored cable modem locations and associated network component topology.

The geographic location of a fault and surrounding network path can be estimated, isolated, and displayed despite minimum information and manually entered data concerning the actual network path or network element location being available. The graphical interface can identify and display specific network elements as problematic. As an example, a network or HFC component that is identified as a suspect component potentially contributing to linear distortion, excessive loss impairments, or the like may be identified and displayed as a location of a fault. Whether a fault impacts a single subscriber or a group of subscribers may also be estimated and shown in the display.

Still further, the network management tool may be used to identify clusters or groups of network elements or cable modems that may share network or HFC infrastructure, such as common components including optics, nodes, amps, cables, taps, passives, and the like. In this regard, Management Information Base (MIB) information for service groups, readily available via data pulls from a CMTS or like equipment at the headend of the network, can be used in conjunction with the above referenced geographical location information. Network element groups or clusters can be readily displayed via the graphical interface and without the need for the software to reference other sources, perform testing, or wait for common impairment signature alarms to be raised.

Still further, the severity of a fault may be estimated with respect to upstream impairments through association of physical layer metrics including pre and post forward error correction (FEC) along with the number of impacted network elements or subscribers. Higher priority alarms can be assigned to groups of network elements or subscribers that exceed threshold values. In contrast, lower priority alarms can be assigned to faults such as detected for single network elements or subscribers.

According to an embodiment, the graphical interface referenced above may be presented in the form of a so-called “dashboard” to a user such as personnel of a network operations center. Critical alarms may be shown across the entire network in a geographical display of the network or parts thereof. In addition, access may be provided to statistics via use of the dashboard to allow the user to monitor the overall health of their network.

By way of example, various snap-shot views of a graphical user interface are provided in FIGS. 1-14. It should be understood that these displays are disclosed for purposes of example only and may be altered as desired.

A first example of a dashboard 10 which may be displayed to a user via a monitor or like electronic display screen is shown in FIG. 1. In this example, a first panel 12 of the dashboard 10 provides information of “Active Alarms” including a list of alarms or potential faults 14, a second panel 16 provides a so-called “Physical View” of the network, and a third panel 18 provides a geographically-accurate street map 20 showing the geographical location of the alarms listed in panel 12 along with the nearest node 22 or other network component. The map 20 may include roads and streets and names thereof. In addition, as best illustrated in FIG. 2, alarms can be overlaid on images 24, for instance satellite images, of the geographical service area in which the alarms are located.

When an issue, fault or alarm is identified, it can be associated and displayed with other issues, faults and alarms based on geographical proximity. For instance, see the alarms 14 within circle 26 in FIG. 1. This group or cluster of alarms provides a visual indicator of the network elements affected and can indicated a center point of a potential problem causing the cluster of alarms. For instance, see the center point 28 in FIG. 2. A user which selects the center point may be provided with a listing of problem network elements or modems. In addition, the cluster of alarms may have a single corresponding “alarm” object to thereby reduce the number of alarms displayed to the user.

After an issue is first identified by the network monitoring and management system, tool or software, the operator or user may be provided with several options to further investigate the apparent problem or problems. For instance, network issues may be isolated by “serving group” or “geographic proximity” (i.e., clustering) and may be prioritized by severity based on the number of customers/subscribers affected and the extent to which faults are service-affecting. The network faults can be linked by the management software to a map interface which enables the fault to be connected to a physical location in the network.

FIGS. 3-11 provide further examples of views of a dashboard which may be displayed to a network operator. Any type or number of available charts, maps, or alert views can be viewed and organized in the dashboard. By way of example, the dashboard 30 shown in FIG. 3 may be configured as a starting point when a user first logs onto the network monitoring and management software or system. Here, a “zoomed-out” view of the network is initially provided to permit an overall view of the network, which may span a large geographic area. Data is collected and analyzed by the network monitoring and management tool to identify a type of fault or faults and the estimated geographic location of the fault(s) solely based on analysis of the data.

FIG. 3 provides an entire network view 32 based on a geographic format and provides an indication of so-called “hot-spots” 34 of alarms. A listing 36 of alarms can be provided in a panel 38 which can also indicate the severity and location of the hot-spots 34. Charts such as a FEC deltas/CMTS channel exceeding threshold chart 40, a Flap deltas/CMTS channel exceeding threshold chart 42, and a CMTS channel utilization threshold crossing chart 44 can be displayed in a panel 46 and correspond to the alarms shown in the listing 36. Of course, these charts provide just a few examples of possible charts. A further example of such a dashboard is shown in FIG. 4 which provides a display of a section of the map 48 in greater detail.

In FIG. 5, a dashboard is shown in which panel 50 provides information on network topology. Here, the topology is provided in a form of a so-called alarm tree which enables a user to gain further information with respect to more narrowly defined sections of the network. For example, the topology could list CMTSs (such as CMTS-1, CMTS-2, CMTS-3, CMTS-4, and CMTS-5). Further, the fiber nodes (i.e., FN-A and FN-B) can be shown for any of the CMTSs and a number of network elements associated with an alarm can be listed. As shown in FIG. 6, the panel 50 can also be expanded to show the number of network elements associated with alarms per severity of alarm (i.e., critical, major, and minor).

A more local view of a street map 52 is shown in FIG. 7. Here a single fiber node 54 of the network is shown as is the network path 56 extending from the node 54 to terminal network elements 58, such as cable modems, serviced via the node 54. The shade (or color, etc.) of the terminal networks elements 58 can be used to visually indicate an alarm on the map 52. For instance, terminal network element 58a is shown in a dark shade (or a particularly color, such as red) which may indicate an alarm of critical severity whereas terminal network elements displayed in lighter shades (other colors, such as yellow) may indicate an alarm of a minor severity. This same map 52 can be further investigated as shown in FIG. 8 in which a geo-proximity cluster 60 is shown highlighted. The path 56 of the cable plant may be estimated and shown such as in FIGS. 7 and 8. If desired, the user of the management tool is able to adjust the path 56 or enter in any known network topology information into the management software or tool should the estimated path and view be inaccurate.

Another view similar to FIG. 7 is shown in the map 62 of FIG. 9. Here the street map 52 has been modified to show actual satellite imagery of the surrounding geographic area. The node 54, path 56, and terminal network elements 58 are overlaid on the satellite imagery as are the alarms and other network topology. For purposes of further investigating a potential network fault, the “cable modems” illustrated in FIG. 9 can be shown in a drop down window 64 such as shown in FIG. 10. Here the MAC address, power status, noise status, upstream reflection status, downstream reflection status, FEC status for each cable modem or terminal network element 58. Some of these cable modems and listed statuses have no alarms whereas others have alarms of “minor” severity while others have alarms of “critical” severity. FIG. 11 shows the ability of the tool to further investigate network issues. Here, measurements corresponding to downstream microreflections in dBs are listed (as absolute and delta values) and shown in a window 66 so that a user may view these or any other values that are or are not the subject of an alarm.

Accordingly, after a network operator center user views the above referenced dashboards and investigates alarms therewith, for instance as shown above, and has identified a particular issue that needs to be resolved, the network monitoring and management tool, software or system can be used to assist the user in sending an appropriate field technician to the correct geographical location. The user can also use the management tool or software to assess the urgency with respect to the need to resolve the issue.

The network monitoring and management system, tool or software can also be used by a service technician in the field. For example, the network monitoring and management software may be run on a remote server that is accessible by the technician such as via a secure wireless web interface. For instance, a mobile device, such as a portable, lap-top, notebook, or tablet computer, a smart phone, or the like may be used to obtain various views, information and maps as discussed above. Accordingly, provided information can be used for rapid, real-time debugging of field issues and provide geographic information, provide real-time monitoring of upstream and downstream performance metrics and error states, and permit a technician to see the interdependency of multiple issues. The above can reduce the need for the technician to access the inside of residences, reduce the number of calls the technician needs to make to the head-end, and enable the technician to update network topology information while in the field. For purposes of this disclosure, “real-time” includes a level of responsiveness that is sufficiently fast to provide meaningful data that reflects current or recent network conditions as well as a level of responsiveness that tolerates a degree of lateness or built-in delay.

A tablet 70 is shown in FIGS. 12-14 that may be used by a field technician to connect to the network monitoring and management software. In FIG. 12, the technician is provided with a display 72 that includes an icon 74 for a list of the CMTSs, an icon 76 for network wide alerts, an icon 78 for scanning or uploading information into the system, and a settings icon 80. FIG. 13 shows a display 82 providing a tabular view of network devices 84 having faults, and FIG. 14 shows a display 86 showing the same network devices 84 in a geographical map-style platform with the closest fiber node 88 or like network component. All of the above provides helpful and useful information to the field technician.

Various methods can be used by the network monitoring and management system, software, and tool described above that enables fault determination, fault location, mapping of the network geographically, displaying of faults with and without network topology information, displaying a cluster of network elements impacted by the same fault, and the severity of the fault. For example, a combination of monitored parameters and network topology information can be used to identify the likely physical locations of cable network defects. This approach is able to be implemented in software utilizing numerical analysis. In addition, a combination of sub-algorithms can be used to locate a common network failure point even when several different and potentially, seemingly unrelated, issues are observed.

According to an embodiment, the tool can be used to identify and estimate issues occurring within the fiber trunk of a cable network, such as a HFC fiber trunk. The fiber trunk of a cable network is defined herein as a portion of the network interconnecting the head end or hubs of the network to nodes which ultimately serve terminal network devices or interconnect to other networks. The terms head end and hub are utilized interchangeable herein.

In this embodiment, data aggregated across an entire network worth of subscribers and data collected within a cable headend or hub location can be analyzed for purposes of identifying issues specifically occurring within the fiber trunk section of the network. When an issue is identified, the issue can automatically be displayed on a geographical map or like display of the management tool to quickly show the location of the issue and significantly reduce the time needed to resolve the issue. In this way, network trunk issues can be proactively and automatically located in the network, the estimated location can be shown on a map to a provider with information concerning the nature and severity of the issue.

The management tool of this embodiment can capture network inventory data about CMTS configurations through automated data collection techniques as well as manual user entry. The tool can also be configured to capture information from the optical head end gear (Optical Broadband Transmission Platform (OBTP)). This data can be leveraged and analyzed to aid in the determination of the existence of issues that may be affecting the cable plant. In addition, fiber node, serving group, and channel data can be collected from the CMTS in conjunction with data entered concerning the Optical Broadband Transmission Platform (OBTP) card assignments for physical fiber node to CMTS mapping to assist in narrowing issues. Thus, issues originating from any of the following can be identified: fiber node; optical delivery; a card on the CMTS; the entire CMTS; and a component above the CMTS in the IP network. Similar techniques can also be utilized to track video channels that serve a fiber node or set of fiber nodes. Accordingly, data gathered from monitoring the network at this level can be used to identify and locate issues within the fiber trunk cable and substantially reduce the amount of time it takes for a field technician to be notified of an issue, locate the fault and restore connectivity.

In addition to the coax plant information of a HFC network that is maintained within the tool of the above described embodiment, the fiber trunk cable route and fiber node associations can also be entered or imported into the tool. With this information, nodes can be viewed as entities which can be assessed for being either in or out of service. When one or more nodes are identified as being out of contact or service, the fault can be identified as being located between the last node that is in service and the first node that is out of service. A node is defined as being out of contact or service when all of the cable modems or other terminal network devices of subscribers associated with that node become unreachable. Thus, the management tool of this embodiment can be used to determine where a fault lies within the network, even when the fault is not located near customer premise where a trouble ticket may have been generated or when an unmanned hub or head end is in use.

The analysis with respect to estimating the location of a fault on the network trunk may include a collection of information including any of the following critical system elements: CMTS; CMTS blades status and assignments; OBTP blades status and assignments; CMTS serving group to fiber node associations; fiber node to customer location associations; customer premise equipment status; and physical plant layout. While not all of this information is mandatory for diagnosis, at least a subset of this information is useful in assessing an issue affecting the network trunk section of a cable network.

For purposes of providing an example with respect to the above described embodiment, a topology 100 of a network trunk 102 is shown in FIG. 15. The network trunk 102 includes a head end 104 which may include a cable modem termination system (CMTS) or like equipment. The head end 104 interconnects to various fiber nodes, 106 to 128, via trunk cable 108 in tree and branch network architecture. Each node is connected to numerous terminal network devices (not shown) of subscribers.

In the example shown in FIG. 15, nodes 106, 108, 110, 112, 114, 116, 118 and 120 are in service or contact with the head end 104; whereas, nodes 122, 124, 126 and 128 are out of service or contact with the head end 104. As stated above, a node is defined as being out of contact or service when all of the cable modems or other terminal network devices of subscribers associated with the node become unreachable by the head end. Further, in this example, the data collected from the CMTS, CMTS blades status and assignments, and OBTP blades status and assignments indicate that the CMTS and OBTP are operating properly and are without issues. Accordingly, the issue in this example is therefore automatically narrowed to the fiber trunk 102 and/or a fiber node.

As discussed above, when one or more nodes are identified as being out of contact or service, the fault is estimated as being located between the last node that is in service and the first node that is out of service. Upon viewing FIG. 15, the node that is out of service and is closest to the head end 104 in the tree and branch network architecture of the network trunk 102 is node 122. In the network trunk path to node 122, node 118 is the last node in service relative to node 122. Thus, the fault is estimated as being a portion 130 of the network trunk 102 extending between nodes 118 and 122. This can be shown on a map and readily communicated to a network operator for an appropriate maintenance response.

For purposes of providing a further example, the same field topology 100 of a network trunk 102 that is shown in FIG. 15 is also shown in FIG. 16. The same nodes indicated as being out of service in FIG. 15 are also out of service in the example provided in FIG. 16. However, in this example, the data collected from the CMTS, CMTS blades status and assignments, and OBTP blades status and assignments indicates that the issue is located in the head end 104. Thus, service technicians are not directed to network cable trunk locations or fiber node locations; rather, a service technician is direct to the head end 104.

For the example shown in FIG. 16, the management tool can be configured to automatically provide a dashboard view as provide in FIG. 17 to a network operator. Here a detailed hub view 132 is displayed which includes a hub view 134 showing an image including the OBTP 136, CMTS 138 and IP network 140. In this example, the OBTP 136 and IP network 140 are each indicated as functioning properly; however, a card 142 or blade of the CMTS 138 is indicated as being the source of an issue. The detailed hub view 132 also includes a geographic map 144 displaying the nodes affected by the bad card 142 of the CMTS 138. Here, a topology of a section of the network trunk 102 to which nodes 122, 124, 126 and 128 that are out-of-service are shown.

FIG. 18 provides a flowchart for the above referenced algorithm with respect to a method of estimating a location of a fault in a network, more specifically, a fault occurring in a network trunk or head end or hub. In step 150, information of a physical layout of the network trunk and the locations of nodes thereon is obtained. In addition, the status of each node connected to the head end via the trunk is detected and accessed as being in-service or out-of-service. See step 152. As discussed above, a node is considered out-of-service when the head end loses communication with all terminal network devices associated with the node. This step can be accomplished, for instance, by receiving information of communication status between the terminal network devices associated with the nodes and the head end.

In step 154, the status of head end network components is monitored for the presence of fault conditions. This step can be accomplished, for instance, by receiving information of a working status of the CMTS as a whole, a working status of each individual CMTS blade and assignment, a working status of each optical head end gear blade and assignment, CMTS serving group to fiber node associations, and fiber node to customer location associations.

In step 156, the location of the fault is automatically estimated as being on the trunk of the network when the head end network components are without a monitored fault condition and when at least one node on the trunk is detected as being out-of-service. Here, the out-of service node is selected as the first out-of service node on a downstream path of the trunk in a direction from the head end to the out-of-service node (i.e., the closest out-of-service node on the path leading from the head end). In addition, the fault can be estimated as being located on a particular section of the trunk extending between the first out-of-service node as described above and a next adjacent in-service node in an upstream path of the trunk in a direction from the first out-of-service node to the head end.

In contrast, in step 158, the location of the fault is automatically estimated as being in the head end network components, and not on the trunk cables, when a fault condition in the head end is monitored regardless of whether or not nodes are detected as being out-of-service.

Finally, in step 160, a geographically-accurate map can be populated with information concerning the geographic location of a trunk section or network component to which the fault is attributed as determined above. This step can include populating a geographic location of each node and a path of the trunk of the network impacted by the fault and a diagnostic alarm identifying the network fault. The map can be displayed with geospatial software. Further, the step of populating the map may include providing a display representing the head end network components and an indication of any part thereof that is estimated as being a source of the fault. When any part of the head end network components is estimated as being the source of the fault, a geographically-accurate map can be populated with a geographic location of a trunk section and any of the nodes serviced by the part of the head end network components estimated as being the source of the fault.

A signal processing electronic device, such as a server, remote server, CMTS or the like can run a software application to provide the above process steps and analysis. In addition, a non-transitory computer readable storage medium having computer program instructions stored thereon that, when executed by a processor, cause the processor to perform the above discussed operations can also be provided.

The above referenced signal processing electronic devices for carrying out the above methods can physically be provided on a circuit board or within another electronic device and can include various processors, microprocessors, controllers, chips, disk drives, and the like. It will be apparent to one of ordinary skill in the art the modules, processors, controllers, units, and the like may be implemented as electronic components, software, hardware or a combination of hardware and software.

While the principles of the invention have been described above in connection with specific networks, devices, apparatus, systems, and methods, it is to be clearly understood that this description is made only by way of example and not as limitation on the scope of the invention as defined in the appended claims.

We claim:

1. A method of estimating a location of a fault in a network, comprising the steps of:
detecting a status of a plurality of nodes connected to a head end of the network via a trunk of the network as being in-service or out-of-service, a node being considered out-of-service when the head end loses communication with all terminal network devices associated with the node;
monitoring a status of head end network components for faults; and
automatically estimating the location of the fault as being on the trunk of the network when the head end network components are without a monitored fault condition and when at least one node on the trunk is detected as being out-of-service.

2. A method according to claim 1, wherein, when the fault is estimated as being located on the trunk of the network, the location of the fault is further estimated as being on a section of the trunk extending between an out-of-service node and a next adjacent in-service node in an upstream path of the trunk leading from the out-of-service node to the head end.

3. A method according to claim 2, wherein the out-of service node being a first out-of service node on a downstream path of the trunk leading from the head end to the out-of-service node.

4. A method according to claim 1, further comprising the step of automatically estimating the location of the fault as being in the head end network components when a fault condition is monitored during said monitoring step.

5. A method according to claim 1, when the network is a hybrid-fiber-coaxial cable (HFC) network, the head end network components include a cable modem termination system (CMTS) and optical head end gear, the nodes are fiber nodes communicating with the head end via optic fibers, and the trunk of the network includes fiber optic cables configured in a tree and branch network structure.

6. A method according to claim 5, wherein said step of monitoring the status of the head end network components includes receiving information selected from the group consisting of a working status of the CMTS as a whole, a working status of each individual CMTS blade and assignment, a working status of each optical head end gear blade and assignment, CMTS serving group to fiber node associations, and fiber node to customer location associations.

7. A method according to claim 1, wherein said step of detecting the status of the plurality of nodes includes receiving information of communication status between the terminal network devices associated with the plurality of nodes on the network and the head end.

8. A method according to claim 1, further comprising the step of receiving information of a physical layout of the trunk of the network and a location of nodes on the trunk.

9. A method according to claim 1, further comprising the step of automatically generating a list including at least one of a section of the trunk and one of the head end network components that is estimated as being a potential source of the fault and requires inspection.

10. The method according to claim 1, further comprising the step of automatically and electronically populating a geographically-accurate map with a geographic location of a trunk section or network component to which the fault is attributed.

11. The method according to claim 10, wherein said step of populating the map includes populating a geographic location of each the plurality of nodes and a path of the trunk of the network impacted by the fault and a diagnostic alarm identifying the network fault.

12. A method according to claim 11, further comprising the step of displaying the map with geospatial software.

13. A method according to claim 10, wherein said step of populating the map includes providing a display representing the head end network components and an indication of any part thereof that is estimated as being a source of the fault.

14. A method according to claim 13, wherein, when any part of the head end network components is estimated as being the source of the fault, said step of populating the map includes populating the geographically-accurate map with a geographic location of a trunk section and any of the plurality of nodes associated with the part of the head end network components estimated as being the source of the fault.

15. A signal processing electronic device for estimating a location of a fault in a network, comprising at least one processing unit configured to:
detect a status of a plurality of nodes connected to a head end of the network via a trunk of the network as being in-service or out-of-service, a node being considered out-of-service when the head end loses communication with all terminal network devices associated with the node;
monitor a status of head end network components for faults; and
automatically estimate the location of the fault as being on the trunk of the network when the head end network components are without a monitored fault condition and when at least one node on the trunk is detected as being out-of-service.

16. A signal processing electronic device according to claim 15, wherein, when the fault is estimated as being located on the trunk of the network, said at least one processing unit is configured to further estimated the location of the fault as being on a section of the trunk extending between an out-of-service node and a next adjacent in-service node in an upstream path of the trunk leading from the out-of-service node to the head end, wherein the out-of service node is a first out-of service node on a downstream path of the trunk leading from the head end to the out-of-service node.

17. A signal processing electronic device according to claim 15, wherein said at least one processing unit is configured to automatically estimate the location of the fault as being in the head end network components when a fault condition is monitored during said monitoring step.

18. A signal processing electronic device according to claim 15, wherein said at least one processing unit is configured to receive information selected from the group consisting of a working status of a cable modem termination system (CMTS) as a whole, a working status of each individual CMTS blade and assignment, a working status of each optical head end gear blade and assignment, CMTS serving group to node associations, node to customer location associations, communication status between the terminal network devices associated with the plurality of nodes on the network and the head end, a physical layout of the trunk of the network, and a location of nodes on the trunk.

19. A signal processing electronic device according to claim 15, wherein said at least one processing unit is configured to automatically and electronically populate a geographically-accurate map with a geographic location of a trunk section or network component to which the fault is attributed.

20. At least one non-transitory computer readable storage medium having computer program instructions stored thereon that, when executed by at least one processor, cause the at least one processor to perform the following operations:
detect a status of a plurality of nodes connected to a head end of the network via a trunk of the network as being in-service or out-of-service, a node being considered out-of-service when the head end loses communication with all terminal network devices associated with the node;
monitor a status of head end network components for faults; and
automatically estimate the location of the fault as being on the trunk of the network when the head end network components are without a monitored fault condition and when at least one node on the trunk is detected as being out-of-service.
